(19) United States
(12) Patent Application Publication
(10) Pub. No.: US 2019/0217905 A1
(43) Pub. Date: Jul. 18, 2019

(54) Robotic Drive Platform

(71) Applicant: David Malinowski, Kitchener (CA)

(72) Inventor: David Malinowski, Kitchener (CA)

(21) Appl. No.: 16/248,766

(22) Filed: Jan. 15, 2019

Related U.S. Application Data
(60) Provisional application No. 62/617,520, filed on Jan. 15, 2018.

(51) Int. Cl. B62D 55/065; B62D 55/125

(52) U.S. Cl. CPC B62D 55/065; B62D 55/075; B62D 55/125

(57) ABSTRACT

A robotic drive platform has a body and a plurality of drive track assemblies oriented parallel to each other along a longitudinal forward-rear direction and rotatably connected to the body about a rotation axis. Each of the drive track assemblies is independently rotatable relative to the body. The track assemblies may be configured to all rotate about the same rotation axis, or a forward pair and a rear pair of track assemblies may be utilized. Independent rotation and control of the track assemblies allows the robotic drive platform to traverse and overcome various obstacles.

The current application claims a priority to the U.S. Provisional Patent application Ser. No. 62/617,520 filed on Jan. 15, 2018.

### FIELD OF THE INVENTION

The present invention relates generally to robotics. More particularly, the present invention relates to a robotic drive platform.

### BACKGROUND OF THE INVENTION

Robotics is an interdisciplinary branch of engineering and science that includes mechanical engineering, electronic engineering, information engineering, computer science, and others. Robotics deals with the design, construction, operation, and use of robots, as well as computer systems for their control, sensory feedback, and information processing.

These technologies are used to develop machines that can substitute for humans and replicate human actions. Robots can be used in many situations and for lots of purposes, but today many are used in dangerous environments (including bomb detection and deactivation), manufacturing processes, or where humans cannot survive (e.g. in space). Robots can take on any form, but some are made to resemble humans in appearance. This is said to help in the acceptance of a robot in certain replicative behaviors usually performed by people. Such robots attempt to replicate walking, lifting, speech, cognition, and basically anything a human can do. Many of today's robots are inspired by nature, contributing to the field of bio-inspired robotics.

It is an objective of the present invention to provide a robotic drive platform that is compact and versatile in its capabilities of navigating around a human environment for performing any specified task.

### BRIEF DESCRIPTION OF THE DRAWINGS

FIG. 1 is a perspective view of the present invention according to one embodiment.

FIG. 2 is a side perspective view of one of the drive track assemblies according to one embodiment.

FIG. 3 is a side perspective cutaway view of the present invention according to one embodiment.

FIG. 4 is a perspective view of an alternate embodiment of the present invention.

FIG. 5 is a general processor connection diagram according to one embodiment.

### DETAIL DESCRIPTIONS OF THE INVENTION

All illustrations of the drawings are for the purpose of describing selected versions of the present invention and are not intended to limit the scope of the present invention. The present invention is to be described in detail and is provided in a manner that establishes a thorough understanding of the present invention. There may be aspects of the present invention that may be practiced or utilized without the implementation of some features as they are described. It should be understood that some details have not been described in detail in order to not unnecessarily obscure focus of the invention. References herein to “the preferred embodiment”, “one embodiment”, “some embodiments”, or “alternative embodiments” should be considered to be illustrating aspects of the present invention that may potentially vary in some instances, and should not be considered to be limiting to the scope of the present invention as a whole.

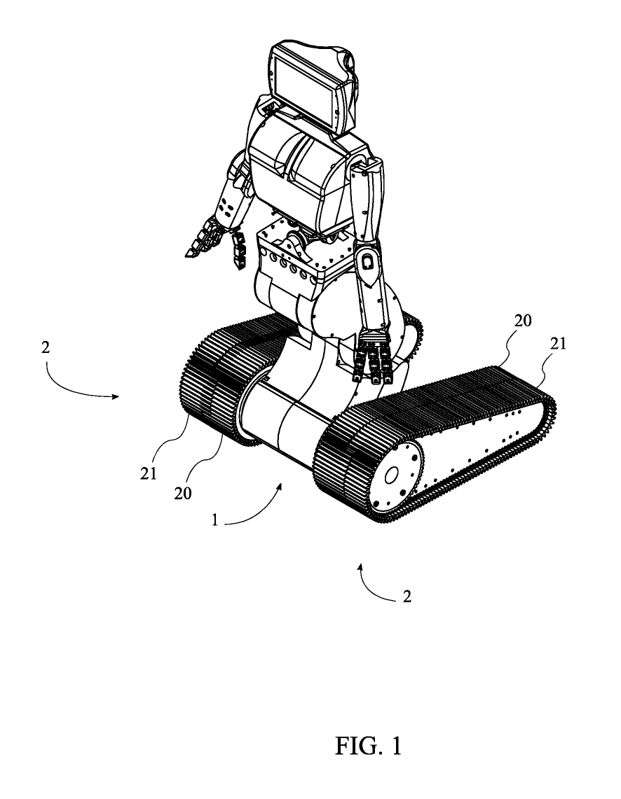

Referring to FIG. 1, the present invention is a robotic drive platform utilizing multiple independently rotatable drive track assemblies 2 connected to a body 1. The present invention is capable of traversing obstacles while maintaining balance through the multiple drive track assemblies 2 and various sensors providing feedback to the system. The body 1 of the present invention may support a variety of upper assemblies for performing various functions. For example, the body 1 may support a robotic body 1 assembly that is humanoid in appearance, comprising a torso, arms, and head.

In general, the present invention comprises a body 1 and a plurality of drive track assemblies 2. Each of the plurality of drive track assemblies 2 is oriented longitudinally. The longitudinal direction should be understood herein to be a forward/rearward direction of travel of the robotic drive platform, with a lateral direction being defined perpendicular to the longitudinal direction in a left-right orientation. Each of the plurality of drive track assemblies 2 is rotatably connected to the body 1 and configured to be independently rotatable relative to the body 1. In the preferred embodiment of the present invention, each of the plurality of drive track assemblies 2 comprises an elongated track configuration, utilizing a drive belt 25 driven by at least one wheel within the track assembly. In some embodiments, the drive track assemblies 2 may be tapered, resembling a “flipper” shape. Furthermore, in the preferred embodiment, each of the drive track assemblies 2 is connected to the body 1 at a proximal end of the drive track assemblies 2, with a distal end of the drive track assemblies 2 being positioned away from the body 1 along the drive track assemblies 2. Furthermore, in the preferred embodiment, each of the drive track assemblies 2 are identical to each other, though in other embodiments, the plurality of drive track assemblies 2 may vary in configuration as desired. The present invention further comprises a main processor 3 that is electronically connected to each of the plurality of drive track assemblies 2 in order to perform control functions through the drive track assemblies 2 in order to propel the robotic drive platform in any desired direction, including traversal over obstacles.

In the preferred embodiment, the plurality of drive track assemblies 2 comprises a first pair of drive track assemblies 20 and a second pair of drive track assemblies 21. It may be generally understood that at least four drive track assemblies 2 are desired to enable the present invention to function as desired, though it is acknowledged that an embodiment with three drive track assemblies 2 may potentially be capable of fulfilling the spirit and purpose of the present invention. Regardless, the present invention is generally preferably configured with multiple pairs of drive track assemblies 2. Each of the first pair of drive track assemblies 20 is positioned laterally opposite each other along the body 1, and each of the second pair of drive track assemblies 21 is similarly positioned laterally opposite each other along the body 1. In some embodiments, the first pair of drive track assemblies 20 and the second pair of drive track assemblies 21 are connected to the body 1 along the same axis of rotation. In some embodiments, the first pair of drive track assemblies 20 and the second pair of drive track assemblies 21 may be connected to the body 1 at different locations, as will be discussed further hereinafter.

It may be noted herein that the configuration of the drive track assemblies 2 may vary in different embodiments. However, it is generally desired that the connection between the drive track assemblies 2 and the body 1 is positioned adjacent to the proximal end of the drive track assemblies 2, while the distal end of the drive track assemblies 2 is capable of rotation in an arc around the proximal end in a “flipper” style configuration.

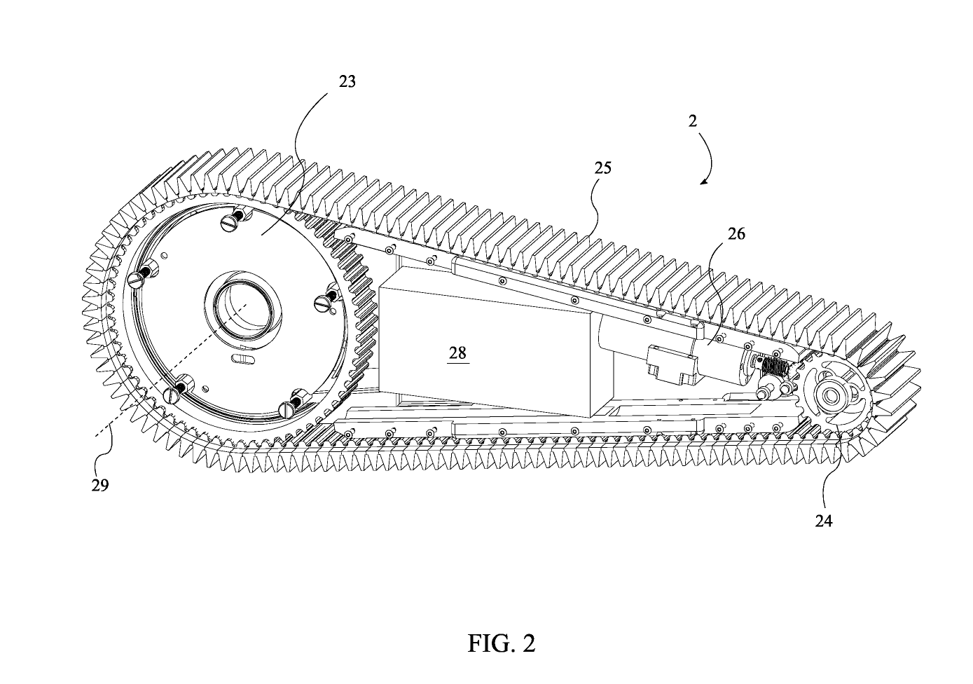

Referring to FIG. 2, in the preferred embodiment of the present invention, each of the plurality of drive track assemblies 2 comprises a proximal wheel 23, a distal wheel 24, a drive belt 25, and a motor 26. The drive belt 25 is operatively engaged around the proximal wheel 23 and the distal wheel 24, and the motor 26 is operatively engaged with the distal wheel 24, wherein the distal wheel 24 is driven by the motor 26, the drive belt 25 is driven by the distal wheel 24, and the proximal wheel 23 is driven by the drive belt 25. Notwithstanding the aforementioned configuration, it should be noted that it is not of particular importance whether the proximal wheel 23 or the distal wheel 24 is driven by the motor 26, and in some embodiments, the proximal wheel 23 may be driven by the motor 26 instead of the distal wheel 24. Preferably, the distal wheel 24 has a smaller diameter than the proximal wheel 23 in order to reduce overall weight and torsional forces applied at the axes of rotation of the drive track assemblies 2. However, in various embodiments the proximal wheel 23 and the distal wheel 24 may be of any desired size.

In some embodiments, an external gearing may be utilized to operatively connect the motor 26 to the proximal wheel 23, or to whichever wheel is driven depending on the configuration.

In general, each of the plurality of drive track assemblies 2 further comprises a rotation axis 29. The rotation axis 29 is an imaginary line about which the respective drive track assembly rotates relative to the body 1. In the preferred embodiment, the rotation axis 29 of each of the plurality of drive track assemblies 2 is oriented laterally, and each of the plurality of drive track assemblies 2 is configured to rotate relative to the body 1 about the rotation axis 29. In the preferred embodiment, for each of the plurality of drive track assemblies 2, the rotation axis 29 is axially aligned with the proximal wheel 23.

In the preferred embodiment of the present invention, the rotation axis 29 of each of the plurality of drive track assemblies 2 is positioned coincident with each other, such that the proximal wheel 23s of each of the plurality of drive track assemblies 2 are concentrically aligned and rotate about the same axis relative to the body 1. In the preferred embodiment, the first pair of drive track assemblies 20 is positioned between the second pair of drive track assemblies 21 and the body 1, such that the first pair of drive track assemblies 20 forms an inner pair of track assemblies and the second pair of drive track assemblies 21 forms an outer pair of track assemblies.

In an alternative embodiment of the present invention, the first pair of drive track assemblies 20 and the second pair of drive track assemblies 21 are connected to the body 1 at different longitudinal locations on the body 1. Thus, the rotation axes of each of the first pair of drive track assemblies 20 are positioned coincident with each other, and the rotation axes of each of the first pair of drive track assemblies 20 are positioned coincident with each other and longitudinally separated from the rotation axes of the first pair of drive track assemblies 20.

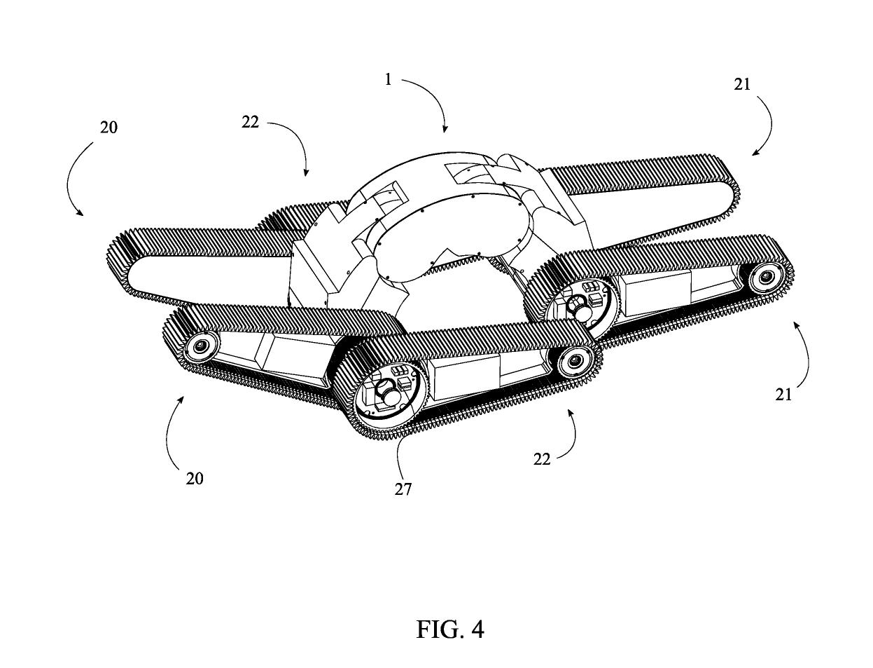

Furthermore, building on the aforementioned alternative embodiment, the plurality of drive track assemblies 2 may further comprise a third pair of drive track assemblies 22 as shown in FIG. 4. In such an embodiment, the first pair of drive track assemblies 20 is positioned between the body 1 and the third pair of drive track assemblies 22, and the rotation axes of the third pair of drive track assemblies 22 is positioned coincident with the rotation axes of the first pair of drive track assemblies 20. Thus, the third pair of drive track assemblies 22 is laterally connected to the first pair of drive track assemblies 20 opposite the body 1. In another variation of said embodiment, the third pair of drive track assemblies 22 may be laterally connected to the second pair of drive track assemblies 21 opposite the body 1, instead of being connected to the first pair of drive track assemblies 20.

Further, the present invention comprises a plurality of track rotation mechanisms 4. Each of the plurality of track rotation mechanisms 4 is operatively connected between the body 1 and the proximal wheel 23 of one of the plurality of drive track assemblies 2, wherein each track rotation mechanism is configured to rotate the one of the drive track assemblies 2 relative to the body 1 about the rotation axis 29 of the one of the drive track assemblies 2.

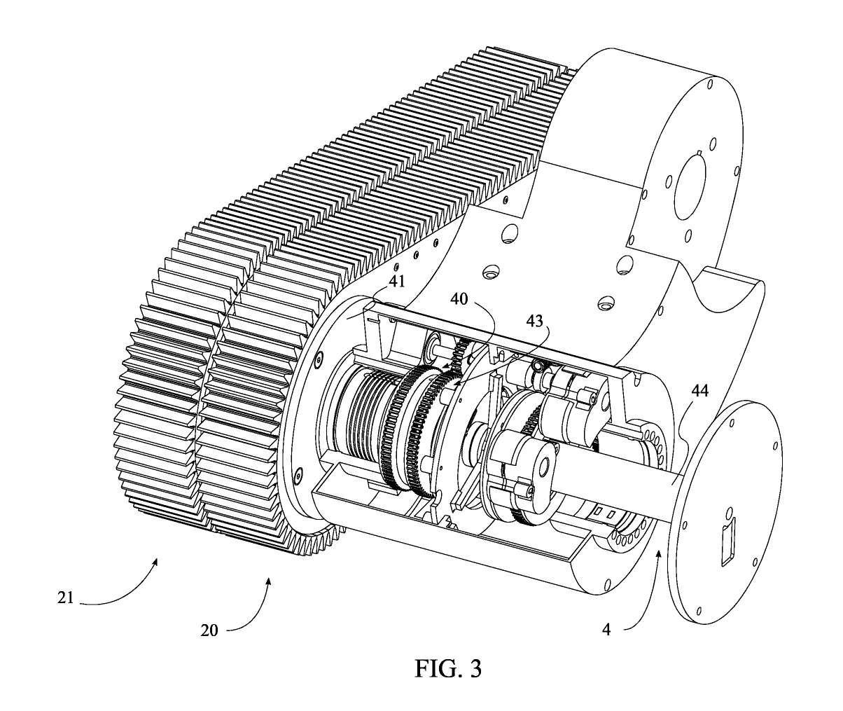

Referring to FIG. 3, further, in the preferred embodiment, the plurality of track rotation mechanisms 4 comprises a first pair of track rotation mechanisms 40 and a second pair of track rotation mechanisms 43. Each of the first pair of track rotation mechanisms 40 comprises an outer shaft 41 and a first motor 42, while each of the second pair of track rotation mechanisms 43 comprises an inner shaft 44 and a second motor 45. The first motor 42 is operatively coupled to the outer shaft 41 for each of the first pair of track rotation mechanisms 40, while the second motor 45 is operatively coupled to the inner shaft 44 for each of the second pair of track rotation mechanisms 43. The outer shaft 41 of each of the first pair of track rotations mechanisms is rotatably coupled to the proximal wheel 23 of one of the first pair of drive track assemblies 20, while the inner shaft 44 of each of the second pair of track rotation mechanisms 43 is rotatably coupled to the proximal wheel 23 of one of the second pair of drive track assemblies 21. The inner shaft 44 of each of the second pair of track rotations mechanisms is positioned concentrically within the outer shaft 41 of one of the first pair of track rotations mechanisms.

In one embodiment, each inner track is connected to the body 1 using a cylindrical shaft. The shaft has a drive gear and a retaining ring holding it in place. Communication from the track to the body 1 is done using a through bore or drum slip ring. A commutator and brushes are further utilized to facilitate electrical communication. The outer track is connected to the body 1 through a shaft which runs through the inner track and the inner track shaft. The outer track shaft has a drive gear and retaining ring identical to the inner track shaft but with a different inner diameter hole and key. Communication on the outer track shaft is done through a pancake slipring. A stator and rotor are further utilized in the configuration. Manipulation of position of the outer and inner tracks is done with an external gearing and a drive motor 26 gearbox assembly. Position feedback for each track is accomplished with an external position sensor which has internal gearing for a 1:1 ratio to the track shaft drive gear.

In an updated embodiment, the internals of the track assemblies are changed from a geared motor with gearing internally and externally to a ring/hub motor design reducing the complexity. Additionally, the tracks' positioning motors have been rearranged again to reduce complexity and improve overall capabilities. Feedback for the tracks has also been redesigned to improve accuracy and reduce parts complexity and space. The updated embodiment utilizes direct drive built into the sprocket without gearing and a more powerful motor.

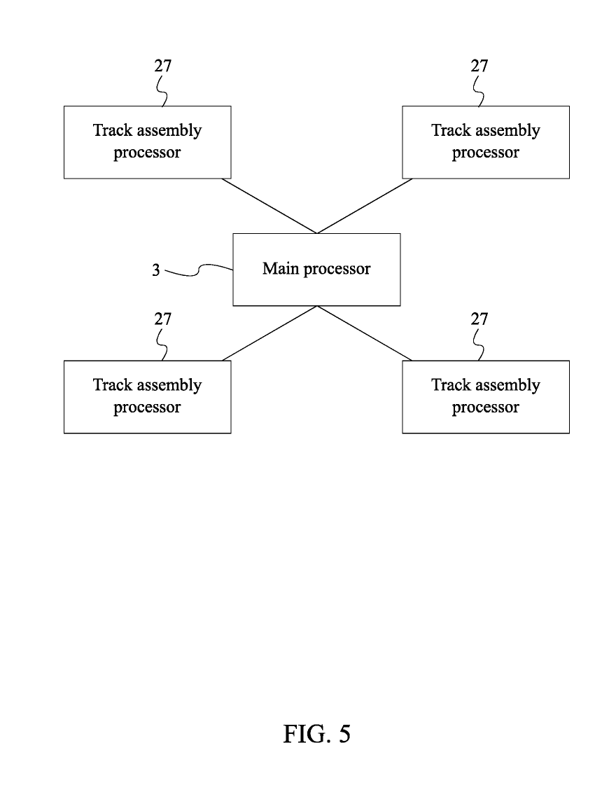

In the preferred embodiment, the present invention further comprises a main processor 3. The main processor 3 generally carries out executive functions, such as, but not limited to, collecting environmental data through various sensors and calculating navigational trajectories. Furthermore, in the preferred embodiment, each of the plurality of drive track assemblies 2 further comprises its own printed circuit board (PCB) comprising a track assembly processor 27, as well as a battery pack 28 that is electrically connected to the motor 26 and the track assembly processor 27. In other embodiments, each track assembly processor 27 may be electrically connected to a primary power source that provides electrical power to the entire system. The track assembly processor 27 is responsible for controlling the motor 26 and receiving signals from any sensors integrated into the track assembly, is electrically connected to the motor 26. The main processor 3 is electronically connected to the track assembly processor 27 of each of the plurality of drive track assemblies 2, as illustrated in FIG. 5. The track assembly processor 27 of each of the plurality of drive track assemblies 2 is configured to perform lower-level functions based on higher level instructions received from the main processor 3. For example, the main processor 3 may send a signal to the track assembly processor 27 of one of the drive track assemblies 2 to operate the drive belt 25 at a specific speed. The track assembly processor 27 then calculates the necessary requirements to fulfill this task, such as power delivery from the battery pack 28 to the motor 26 in order to actuate the motor 26 as the speed required to operate the drive belt 25 at the desired speed.

In the preferred embodiment, each drive track assembly further comprises one or more feedback sensors in and/or on the motor 26 or motors or in other locations giving absolute position of each track and how it moves. Each track assembly can further sense any forces applied or changed through any relevant sensors, such as, but not limited to, gyroscopes or accelerometers.

The track assembly processor 27 generally performs tasks such as, but not limited to, managing the battery pack 28, managing feedback and/or torque from the motor 26, measuring and/or monitoring torque and any external forces applies, monitoring onboard sensors and relaying sensor signals back to the main processor 3 through a controller area network (CAN) bus. Using the CAN bus, the main processor 3 sends commands to the track assembly processor 27; for example, move to angle X. The track assembly processor 27 then moves the track assembly to angle X with a specified amount of torque. The distance from the old position to the new position is calculated, and depending on the distance, the track assembly processor 27 may change the speed of the track to be faster or slower and then hold that speed once it is achieved.

It may be understood that a variety of different sensors or sensor packages may be integrated into any desired location of the present invention in order to facilitate its desired operation, such as, but not limited to, gyroscopes, magnetometers, and accelerometers, linear position sensors, angular position sensors, optical sensors such as cameras, radar, LIDAR, laser rangefinders, or other sensors.

The following is a general process the present invention may follow in order to traverse over an obstacle in accordance with some embodiments.

Steps Robot Follows to Overcome Obstacle:

1,2—Robot in its upright balancing mode. Small footprint on ground similar to a Segway. Robot uses internal gyro, accelerometer magnetometer feedback sensors and cameras to balance and move about its environment to avoid obstacles or to climb over them.

3,4—Robot balancing, spreads tracks to make large footprint on ground and to start the obstacle climbing sequence. Robot uses track position sensors, gyro, accelerometer, cameras and other feedback sensors to learn when contact has been made on all 4 tracks.

5—Robot starts to move over obstacle. Using gyro, accelerometer internal sensors and feedback robot raises while holding its upright posture until it reaches the satisfactory elevation.

6,7—Robot starts to move over obstacle. Using gyro, accelerometer internal sensors and feedback robot moves forward while holding its upright posture until its calculated distance is passed and it senses that the back track has made contact with the obstacle.

8,9—Robot moves over obstacle. With a calculated distance and sensors robot moves to other end of obstacle while maintaining balance.

10,11—Robot reverses the steps from 6,7.

12—Robot reverses the steps from 5

13—Robot reconfigures back to balancing robot and moves on.

14,15,16—Robot can move around the environment in a stable configuration yet apply same settings to climb over obstacles.

The following is an exemplary logical process flow to be implemented through programming code executing by the main processor and track assembly processors in order to accomplish the above obstacle traversal process, and is not intended to be limiting:

1,2)

Robot receives command to move to new location:
Scan environment along path for walls/obstacles
If clear move towards new location until obstacle is in the way.
Decision: (Around/Over obstacle)
Over obstacle

3,4)
Keep balance
Lower tracks
   If feedback from gyro—adjust body
   If feedback from a track—stop that track
   Continue until all tracks make contact with ground/obstacle

5)
Continue lowering tracks at varied speeds to maintain balance
   If feedback from gyro adjust speed to track(s) to compensate
   Once desired height reached stop all tracks

6)
Adjust body position for best calculated center of gravity

7)
Move forward calculated distance
   if feedback from gyro—stop
      Check if rear track made contact with obstacle
         if yes move to step 8

8)
Raise rear track to calculated angle

9)
Move forward till CG reached edge of obstacle

10)
lower front track
   if feedback from gyro—stop track
   if feedback from track sensor—stop

11)
move forward calculated distance
   if feedback from gyro—stop

12)
Continue raising tracks at varied speeds to maintain balance
   If feedback from gyro adjust speed to track(s) to compensate
   Once desired height reached stop all tracks

13)

Set tracks to desired traveling position and move towards end point.

Although the invention has been explained in relation to its preferred embodiment, it is to be understood that many other possible modifications and variations can be made without departing from the spirit and scope of the invention as hereinafter claimed.

What is claimed is:

1. A robotic drive platform comprises:
a body;
a plurality of drive track assemblies;
each of the plurality of drive track assemblies being oriented longitudinally;
each of the plurality of drive track assemblies being rotatably connected to the body;
each of the plurality of drive track assemblies being configured to be independently rotatable relative to the body;
the plurality of drive track assemblies comprises a first pair of drive track assemblies and a second pair of drive track assemblies;
each of the first pair of drive track assemblies being positioned laterally opposite each other along the body; and
each of the second pair of drive track assemblies being positioned laterally opposite each other along the body.

2. The robotic drive platform as claimed in claim 1 comprises:
a main processor; and
the main processor being electronically connected to each of the plurality of drive track assemblies.

3. The robotic drive platform as claimed in claim 1 comprises:
each of the plurality of drive track assemblies comprises a proximal wheel, a distal wheel, a drive belt, and a motor;
the drive belt being operatively engaged around the proximal wheel and the distal wheel; and
the motor being operatively engaged with the distal wheel, wherein the distal wheel is driven by the motor, the drive belt is driven by the distal wheel, and the proximal wheel is driven by the drive belt.

4. The robotic drive platform as claimed in claim 3 comprises:
a main processor;
each of the plurality of drive track assemblies further comprises a track assembly processor;
the track assembly processor being electrically connected to the motor; and
the main processor being electronically connected to the track assembly processor of each of the plurality of drive track assemblies.

5. The robotic drive platform as claimed in claim 3 comprises:
each of the plurality of drive track assemblies further comprises a battery pack; and
the battery pack being electrically connected to the motor and the track assembly processor for each of the plurality of drive track assemblies.

6. The robotic drive platform as claimed in claim 1 comprises:
each of the plurality of drive track assemblies further comprises a rotation axis;
the rotation axis being oriented laterally; and
each of the plurality of drive track assemblies being configured to rotate relative to the body about the rotation axis.

7. The robotic drive platform as claimed in claim 6 comprises:
each of the plurality of drive track assemblies further comprises a proximal wheel; and
the rotation axis being axially aligned with the proximal wheel for each of the plurality of drive track assemblies.

8. The robotic drive platform as claimed in claim 1 comprises:
the first pair of drive track assemblies being positioned between the second pair of drive track assemblies and the body.

9. The robotic drive platform as claimed in claim 1 comprises:
each of the plurality of drive track assemblies further comprises a rotation axis; and
the rotation axes of each of the plurality of drive track assemblies being positioned coincident with each other.

10. The robotic drive platform as claimed in claim 1 comprises:
each of the plurality of drive track assemblies further comprises a rotation axis;
the rotation axes of each of the first pair of drive track assemblies being positioned coincident with each other; and
the rotation axes of each of the second pair of drive track assemblies being positioned coincident with each other and longitudinally separated from the rotation axes of the first pair of drive track assemblies.

11. The robotic drive platform as claimed in claim 10 comprises:
the plurality of drive track assemblies further comprises a third pair of drive track assemblies;
the first pair of drive track assemblies being positioned between the body and the third pair of drive track assemblies; and
the rotation axes of the third pair of drive track assemblies being positioned coincident with the rotation axes of the first pair of drive track assemblies.

12. The robotic drive platform as claimed in claim 1 comprises:
a plurality of track rotation mechanisms; and
each of the plurality of track rotation mechanisms being operatively connected between the body and a proximal wheel of one of the plurality of drive track assemblies, wherein each track rotation mechanism is configured to rotate the one of the drive track assemblies relative to the body about a rotation axis of the one of the drive track assemblies.

13. The robotic drive platform as claimed in claim 1 comprises:
the plurality of track rotation mechanisms comprises a first pair of track rotation mechanisms and a second pair of track rotation mechanisms;
each of the first pair of track rotation mechanisms comprises an outer shaft and a first motor;
each of the second pair of track rotation mechanisms comprises an inner shaft and a second motor;
the first motor being operatively coupled to the outer shaft;
the second motor being operatively coupled to the inner shaft;
the outer shaft of each of the first pair of track rotation mechanisms being rotatably coupled to a proximal wheel of one of the first pair of drive track assemblies;
the inner shaft of each of the second pair of track rotation mechanisms being rotatably coupled to a proximal wheel of one of the second pair of drive track assemblies; and
the inner shaft of each of the second pair of track rotation mechanisms being positioned concentrically within the outer shaft of one of the first pair of track rotation mechanisms.
